(19) United States
(12) Patent Application Publication
(10) Pub. No.: US 2021/0384528 A1
(43) Pub. Date: Dec. 9, 2021

(54) METHOD OF PRODUCING A SEPARATOR PLATE

(71) Applicants: Karl Wörwag Lack- und Farbenfabrik GmbH & Co. KG, Korntal-Munchingen (DE); Daimler AG, Stuttgart (DE)

(72) Inventors: Helge Warta, Ditzingen (DE); Fritz Wazula, Calw (DE)

(21) Appl. No.: 17/285,933

(22) PCT Filed: Oct. 15, 2019
(86) PCT No.: PCT/EP2019/077902

§ 371 Date: Apr. 16, 2021

(30) Foreign Application Priority Data
Oct. 18, 2018 (DE) 10 2018 008 249.1

(51) Int. Cl. H01M 8/0226; H01M 8/0206; H01M 8/0221

(52) U.S. Cl. CPC H01M 8/0226; H01M 8/0221; H01M 8/0206

(57) ABSTRACT

A method of producing a separator plate for a fuel cell, for which at least one curable material provided with electrically conducting fillers is used including aligning the electrically conducting fillers by an electrical and/or magnetic field, and, subsequently, curing the material with the electrically conducting fillers in the aligned orientation.

### TECHNICAL FIELD

This disclosure relates to a method of producing a separator plate and a separator plate obtainable by the method.

### BACKGROUND

Separator plates, which are also designed as bipolar plates and are inserted into fuel cells during their production, are known. They must have a certain electrical conductivity for which reason they are, for example, produced from graphite or metal. Furthermore, it is known in principle to produce such separator plates from a plastic provided with electrical conductivity by way of electrically conductive particles such as, for example, carbon black or graphite as fillers. A method of producing such a separator plate is known, for example, from DE 10 2016 015 318 A1. In that method, a polymer matrix is applied to a film and provided with the desired shaping. The material is then cured. Electrically conductive particles of graphite or carbon black are present in the material so that the setup is produced altogether with a largely homogeneous electrical conductivity.

In practice, a higher electrical conductivity is desirable. This can be achieved, for example, by a higher proportion of the electrically conductive fillers which, however, adversely influences the mechanical properties of the material if the same dimensions are maintained or necessitates greater dimensions, which is extremely undesirable with regard to the power density or the power per unit volume of fuel cells.

EP 1 331 685 B1 discloses a polymer matrix provided with electrically conducting fillers is used. To increase significantly the electrical conductivity of the separator plate with a relatively low degree of filling, it is proposed that parts of the polymer matrix are destroyed by pyrolysis to achieve a direct connection of the electrically conductive particles. The pyrolysis may be achieved in particular by exposure to the effect of electromagnetic radiation, for example, microwave radiation. The disadvantage is the relatively complex process in which the already finished separator plate has to be subjected to subsequent treatment by electromagnetic radiation and pyrolysis. Furthermore, restricting the pyrolysis to the desired regions, and thus achieving a targeted increase in the electrical conductivity, is a relatively complex undertaking. Furthermore, matrix material is lost as a result of the pyrolysis. Hence, when increasing the degree of filling, additional matrix material already has to be provided during production to ensure the mechanical properties of the material. This is typically accompanied by an increase in the volume of the separator plate. This represents a disadvantage with regard to the power per unit volume of a fuel cell made up of such separator plates.

It could therefore be helpful to provide a method of producing a separator plate and also a separator plate obtainable by the method allowing higher electrical conductivity with undiminished mechanical material properties and undiminished size.

### SUMMARY

We provide a method of producing a separator plate for a fuel cell, for which at least one curable material provided with electrically conducting fillers is used, including aligning the electrically conducting fillers by an electrical and/or magnetic field and, subsequently, curing the material with the electrically conducting fillers in the aligned orientation.

We also provide a separator plate obtained by the method of producing a separator plate for a fuel cell, for which at least one curable material provided with electrically conducting fillers is used, including aligning the electrically conducting fillers by an electrical and/or magnetic field and, subsequently, curing the material with the electrically conducting fillers in the aligned orientation.

### BRIEF DESCRIPTION OF THE DRAWINGS

FIG. 1 shows a schematic representation of a production installation for producing separator plates for fuel cells.

FIG. 2 shows an enlarged representation of a produced separator plate in plan view.

### DETAILED DESCRIPTION

The method of producing a separator plate for a fuel cell uses a curable material provided with electrically conducting fillers, for example, such as in DE 10 2016 015 318 A1. This mixture can be processed correspondingly, for example, in that, as it is applied to a carrier film, and in that a flow field with raised and lowered regions is formed or the like. However, this is only an example and not imperative for our method.

We therefore provide, in a method step before curing the material, that the electrically conductive fillers are oriented by way of an electrical and/or magnetic field, and then the material is cured with the electrically conducting fillers in the aligned orientation. The entire material mixture is consequently preserved intact and in the desired way so that the desired mechanical workpiece properties can be achieved without additional material and/or volume. Thus, at least some of the electrically conducting fillers are aligned in the material, as long as it is still liquid or viscous, by way of an electromagnetic field or an electrical field or a magnetic field. This alignment of the electrically conducting fillers in the material produces a higher electrical conductivity since they orient themselves, for example, along the field lines and become concentrated there. In this state of orientation of the fillers, curing then takes place, for example, in that the material becomes highly viscous by a pre-heating so that a re-orientation of the electrically conductive fillers is prevented before they are permanently cured in the desired orientation with the material without being in the electromagnetic field any longer, for example, by exposure to the effect of heat, UV light or the like, as disclosed in DE 10 2016 015 318 A1.

A very advantageous refinement of our method is that the electrically conducting fillers take the form of metallic fillers. Advantageously, the metallic fillers may comprise silver in particular, which ensures high electrical conductivity along with sufficient material stability.

Particularly favorably, the electrically conducting fillers take the form of a powder or the form of nanoparticles, nanotubes or nanowires. Dispensing with fibrous fillers, or using nanoparticles, nanotubes or nanowires as fillers, achieves the effect that the fillers have great mobility in the still liquid or viscous material of the later polymer matrix so that particularly easy alignment of the electrically conducting fillers in the electromagnetic field becomes possible, which is a decisive advantage with regard to the high conductivity to be achieved of the separator plate produced by our method.

Extremely favorably, the fillers take the form of, or at least comprise, silver nanowires. Such silver nanowires may have a diameter of 30 to 50 nm and a length of 10 to 40 μm. Typically, they are provided in stabilized dispersions, which can be ideally mixed with the still liquid matrix material, for example, before the latter is applied to a carrier film to keep with the preferred but not absolutely necessary method already referred to in DE 10 2016 015 318 A1. These silver nanowires may have sufficient mobility in the still liquid material and ensure very good electrical conductivity after alignment, without adversely influencing the mechanical material properties of the separator plate in the regions in which they are correspondingly concentrated and aligned.

Favorably, the electrical and/or magnetic field is aligned such that regions with electrical conductivity and regions with electrical isolation are formed. A corresponding field therefore allows the effect to be achieved that specific individual regions of the separator plate have a high electrical conductivity because the electrically conducting fillers, in particular the nanowires of silver, are concentrated and aligned there. This may in particular occur along the field lines of the field. In between, regions with little alignment and little concentration of electrically conducting fillers are obtained so that in these regions an electrical isolation is possible, or at least a greatly reduced electrical conductivity compared to the neighboring regions. This may be a decisive advantage for the design of a corresponding separator plate since electrical conductivities that are individually suitable for the respective requirements and the respective flow field can thus be provided. When used as a bipolar plate, the two surfaces facing the respective cells of the fuel cell can, for example, be electrically delimited, in particular isolated, from one another without additional expenditure of material and without additional components and installation space.

A separator plate obtainable by our method in one of the examples described above can thus be used correspondingly as a separator plate or bipolar plate in a fuel cell stack, for example, to form a lightweight, compact and inexpensively producible PEM fuel cell stack, which can be used to provide electrical power, for example, in a motor vehicle.

Further advantages are also provided by the example that is described more specifically below with reference to the figures.

Our method is explained below on the basis of the method in DE 10 2016 015 318 A1. It does not necessarily have to be carried out with all of the steps according to this method since our method is constituted by the step of an electromagnetic alignment of the electrically conductive fillers. It can however be used in such a method and is described below on the basis of such a method purely by way of example.

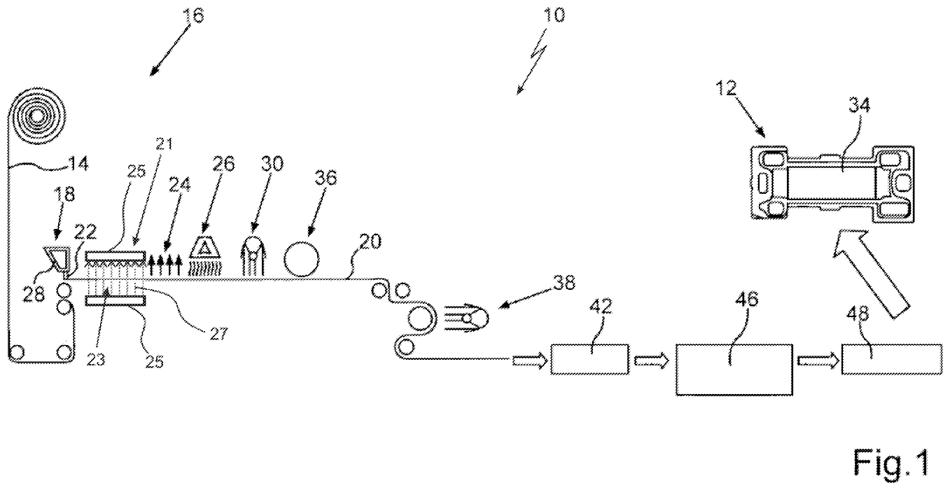

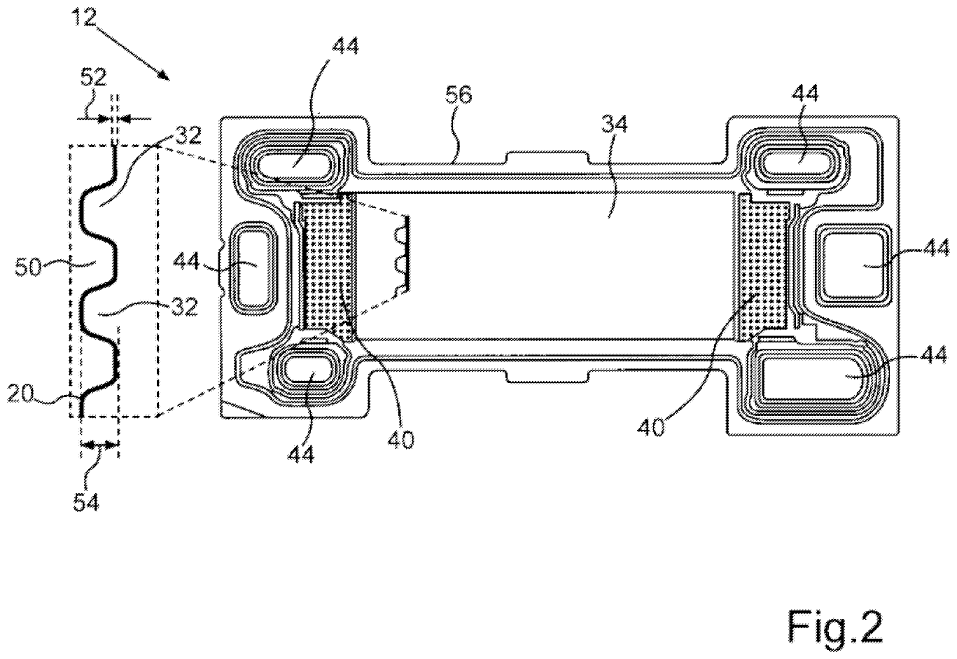

A production installation 10, schematically shown in FIG. 1, serves for the production of separator plates, a bipolar separator plate in the form of a bipolar plate 12 that can be produced in the production installation 10 being shown in FIG. 2 in a plan view. The bipolar plates 12 are intended for fuel cells of a fuel cell stack, as can be used for instance in a motor vehicle.

In the production of the bipolar plates 12, first a carrier material is provided, in this example in the form of a carrier film 14. The carrier film 14 may be in a state in which it is wound up on a roll 16. A film of thermally stabilized plastic may be used in particular as the carrier film 14.

The carrier film 14 is unwound from the roll 16 and subsequently fed to further processing stations of the production installation 10. At a first processing station 18, a mixture 28 comprising an electrically conductive material 20 is applied to the carrier film 14, it being possible for the mixture 28 to be cured. For example, the mixture 28, which comprises a polymer resin, for example, an epoxy resin and/or acrylic resin, at least one solvent, photoinitiators and electrically conductive fillers, may be applied to the carrier film 14 by way of a slot die 22 or similar application device. In addition, the mixture 28 may also comprise further fillers. The conductive fillers take the form of metallic electrically conducting fillers. They may preferably comprise silver and particularly preferably take the form of a powder or the form of nanoparticles. The nanoparticles may in this example comprise nanoparticles, nanotubes, or in particular nanowires. It is particularly favorable if, to achieve electrical conductivity, the metallic fillers take the form of silver nanowires, which have diameters of the order of magnitude of 30 to 50 nm and a length of 10 to 40 μm. These on the one hand ensure good electrical conductivity and on the other hand can move largely freely in the mixture 28, as long as the latter is still liquid or relatively strongly viscous.

For this purpose, after applying the still liquid or relatively strongly viscous mixture 28 to the carrier film 14, the mixture 28 with the metallic fillers still freely movable therein is exposed to the effect of an electromagnetic field 23 in a first processing station 21. The electromagnetic field 23 may take the form of a single electromagnetic field or else the form of a number of electromagnetic fields superposed on one another or else a number of electromagnetic fields arranged one behind the other in the direction of production 10. Shown purely by way of example in the representation of FIG. 1 are two active elements 25 with field lines 27 formed between them, which act correspondingly on the mixture with the metallic fillers that is located on the carrier film 14.

A corresponding configuration of the electromagnetic field 23 or the superposed or successively acting electromagnetic fields 23 in the processing station 21 therefore brings about a targeted alignment of the metallic fillers along the field lines 27 of the electromagnetic fields 23. This allows the electrical conductivity of the setup to be largely freely designed so that regions with high electrical conductivity in which the metallic fillers are concentrated and correspondingly aligned are produced. At the same time, regions with a low concentration and a largely homogeneous distribution of the remaining metallic fillers can be achieved so that here there is a low electrical conductivity or ideally even an electrically isolating property. This opens up completely new ways of designing separator plates, in particular bipolar plates 12. For example, regions can be isolated from one another or electrical conductivity only provided in regions that are later facing the respectively neighboring cell of the fuel cell stack and, therefore, require this electrical conductivity, while the regions facing away from the surface of the neighboring cell in a flow field do not require the electrical conductivity and can accordingly be formed without it. In particular, the two opposing surfaces of the bipolar plate 12 can also be electrically isolated from another or at least electrically separated from one another by a region of low electrical conductivity, which is a further advantage.

At a following processing station 24, the solvent is allowed to evaporate out of the mixture 28. As a result, the consistency and viscosity of the mixture 28 changes. For example, the mixture 28 that has been applied to the carrier film 14 is subsequently pre-dried by a heating device 26. Subjecting the mixture 28 to heat at the heating device 26 leads in this example to the gelling or initial gelling of the mixture 28. At a following, optional processing station 30, the mixture 28 may additionally be partially cured or pre-cured, the orientation of the metallic fillers that is provided by the electromagnetic field being retained. For this, the mixture 28 may be exposed to light, in particular to radiation such as, for example, UV light, at the processing station 30.

Subsequently, structures are introduced into the initially gelled or partially cured mixture 28, for instance in the form of channels 32 (compare FIG. 2), which form a flow field 34 in the finished bipolar plate 12. A corresponding setting of the proportion of the solvent and the solids in the mixture 28 can achieve the effect that desired surface structures can be formed in the material 20 that has been pre-dried or initially gelled and/or partially cured by UV light at the processing station 30.

To form the surface structures of the bipolar plate 12 comprising the flow field 34, an embossing tool, in particular a two-part embossing tool, may be used, for example, as the tool 36. In addition or as an alternative, the structuring may be performed by a tool 36 suitable for roll forming or roll profiling. In particular, the channels 32 or groove structures can be formed in the mixture 28 in this way.

The flow field 34 (compare FIG. 2) formed by the corresponding tool 36 makes it possible to subject a membrane-electrode arrangement (not shown) of the fuel cell to a reactant, for example, to hydrogen as the fuel or to oxygen or air as the oxidizing agent.

Furthermore, by the tool 36, structural elements that are provided in the bipolar plate 12 in a respective transitional region 40 between the flow field 34 and corresponding inlets or outlets for the reactants involved in the fuel cell reaction (compare FIG. 2), can be provided on surface structures.

As a result of the photoinitiators being provided in the mixture 28, in a following processing step the mixture 28 can be completely cured. For this, a corresponding light source 38, in particular UV light source, is provided at a further processing station. After the curing of the material 20, for instance by the UV light emitted by the light source 38, the corresponding structures are permanently formed in the mixture 28.

In a following processing step, a plurality of passages 44 can be formed, for example, by punching 42 (compare FIG. 2). Usually, a fuel inlet and a fuel outlet, an oxidizing agent inlet and an oxidizing agent outlet as well as a coolant inlet and a coolant outlet are provided by such passages 44. In the fuel cells stacked one on top of the other, these passages 44 form corresponding channels for supplying and removing the reactants or the coolant. Adding metallic fillers has the effect of increasing the cooling capacity of the bipolar plate, because of their higher thermal conductivity.

Cutting to size 46 in a following processing step or at a following processing station allows an outer contour 56 of the bipolar plate 12 to be produced as desired. For the cutting to size 46, a laser or the like may be used in particular. Furthermore, by a laser, regions can be removed from the cured mixture 28 to form desired structures in the bipolar plate 12.

The cured mixture 28 can otherwise be connected by a suitable joining process, in particular by adhesive bonding, to a further part that is formed as described above from the mixture 28. Accordingly, a first partial plate of the bipolar plate 12, which can be connected by joining 48 to a second partial plate of the bipolar plate 12, may be provided. In this way, a flow field for a coolant can be provided in a hollow space or intermediate space 50 between two such partial plates (compare FIG. 2). Preferably, a thickness 52 of the cured mixture 28 (compare FIG. 2) is very small. In particular, the thickness 52 is preferably much smaller than a depth 54 of the grooves or channels 32 that are formed in the region of the flow field 34 for the reactant or in the region of the flow field for the coolant.

Furthermore, the cured mixture 28 is impermeable with respect to air or oxygen and with respect to hydrogen. In addition, it has a sufficient mechanical strength and structural integrity to provide the bipolar plates 12 that are to be used in the fuel cells of the fuel cell stack.

The carrier film 14 provided with the cured mixture 28 may also be initially provided as an intermediate product or semifinished product, before it is given its final form by corresponding further processing steps such as for instance the punching 42, the cutting to size 46 or the joining 48 of the bipolar plate 12. The intermediate product may in particular be wound up to form a roll.

It may also be provided that regions such as for instance the passages 44 are cut out from the carrier film 14 provided with the cured mixture 28, and so an intermediate product or a semifinished product comprising the carrier film 14 with the cured mixture 28 is provided, and in particular is wound up to form a roll. Then, after detaching the cured mixture 28 from the carrier film 14, the bipolar plate 12 with the desired outer contour 56 can be formed from such an intermediate product by the cutting to size 46 and the joining 48. In particular, first the intermediate product can be cut to size and, after the detaching of the material 20 from the carrier film 14, the bipolar plate 12 can be formed by joining the partial plates thus obtained.

1-8. (canceled)

9. A method of producing a separator plate for a fuel cell, for which at least one curable material provided with electrically conducting fillers is used comprising aligning the electrically conducting fillers by an electrical and/or magnetic field, and, subsequently, curing the material with the electrically conducting fillers in the aligned orientation.

10. The method as claimed in claim 9, wherein metallic fillers are used as electrically conducting fillers.

11. The method as claimed in claim 9, wherein the electrically conducting fillers comprise silver.

12. The method as claimed in claim 9, wherein the electrically conducting fillers are in the form of a powder.

13. The method as claimed in claim 9, wherein the electrically conducting fillers are in the form of nanoparticles, nanotubes or nanowires.

14. The method as claimed in claim 11, wherein the electrically conductive fillers are in the form of silver nanowires.

15. The method as claimed in claim 9, wherein the electrical and/or magnetic field is formed such that regions with electrical conductivity and regions without electrical conductivity are formed in the still liquid mixture.

16. A separator plate obtained by the method according to claim 9.
